(19) United States
(12) Patent Application Publication
(10) Pub. No.: US 2026/0343477 A1
(43) Pub. Date: Oct. 29, 2026

(54) ENHANCED INDOOR POSITIONING

(71) Applicant: QUALCOMM Incorporated, San Diego, CA (US)

(72) Inventors: Benjamin TARLOW, Cambridge (GB); Thomas ALLAN, St Neots (GB)

(21) Appl. No.: 19/193,472

(22) Filed: Apr. 29, 2025

(51) Int. Cl. H04W 64/00; H04W 4/33; H04W 24/10

(52) U.S. Cl. CPC H04W 64/00; H04W 4/33; H04W 24/10

(57) ABSTRACT

System and methods are disclosed for obtaining a plurality of measurements of radio frequency (RF) signals transmitted by a plurality of beacons deployed within an indoor environment, wherein the measurements are performed by a mobile device; obtaining translated coordinates for at least one beacon in the plurality of beacons deployed in the indoor environment, wherein the translated coordinates of the at least one beacon are different from physical coordinates associated with the at least one beacon; and determining an estimated position of the mobile device based at least in part on the translated coordinates of the at least one beacon.

### FIELD OF DISCLOSURE

The present disclosure relates generally to the field of wireless positioning and, more specifically, to improved positioning in an indoor venue.

### BACKGROUND

Positioning systems deployed in retail environments can offer many benefits to retailers. As an example, a positioning system can determine the location of a person (e.g., store employee, customer, etc.), for example, using radio frequency (RF) signals transmitted and/or received by a mobile device being carried by the person. As another example, a positioning system may enable the provisioning of electronic alerts when the person gets within a threshold proximity of an item of interest.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method of estimating a position of a mobile device located within an indoor environment. The method also includes obtaining a plurality of measurements of radio frequency (RF) signals transmitted by a plurality of beacons deployed within the indoor environment, where the measurements are performed by the mobile device. The method also includes determining obtaining translated coordinates for at least one beacon in the plurality of beacons deployed in the indoor environment, where the translated coordinates of the at least one beacon are different from physical coordinates associated with the at least one beacon. The method also includes determining an estimated position of the mobile device based at least in part on the translated coordinates of the at least one beacon. Other embodiments of this aspect include corresponding computer systems, apparatus, and computer programs recorded on one or more computer storage devices, each configured to perform the actions of the methods.

Implementations may include one or more of the following features. The method where the indoor environment is a retail store, and where the at least one beacon corresponds to an electronic shelf label (ESL) placed within the retail store. The estimated position of the mobile device is displayed in a map of the retail store provided by a software application running on the mobile device. The translated coordinates for the at least one beacon are offset from the physical coordinates associated with the at least one beacon. The translated coordinates for the at least one beacon are determined based at least in part on a density of beacons in an area of the indoor environment in which the at least one beacon is also located. The translated coordinates for the at least one beacon are determined based on at least an expected interference associated with the at least one beacon, whether the at least one beacon is expected to be active at a given time, a floor plan of the indoor environment, or a combination thereof. The at least one beacon corresponds to an electronic shelf label (ESL) placed along an aisle within the indoor environment, and where the translated coordinates for the at least one beacon are determined based on a projection of the physical coordinates of the at least one beacon towards a center of the aisle. The translated coordinates for the at least one beacon are provided in an assistance data message by a server of a positioning system. The translated coordinates for the at least one beacon are determined based at least in part on information included in an assistance message provided by a server of a positioning system, where the assistance data message provides at least orientation information associated with the at least one beacon. The translated coordinates for the at least one beacon are determined based at least in part on a Voronoi diagram that partitions the indoor environment into a plurality of regions that each correspond to a beacon in the plurality of beacons, and where the translated coordinates correspond to a centroid of a region corresponding to the at least one beacon. Implementations of the described techniques may include hardware, a method or process, or computer software on a computer-accessible medium.

One general aspect includes a computer system for estimating a position of a mobile device located within an indoor environment. The computer system also includes at least one communication interface. The system also includes at least one memory. The system also includes at least one processor communicatively coupled with the at least one communication interface and at least one memory, the at least one processor configured to:. The system also includes obtain a plurality of measurements of radio frequency (RF) signals transmitted by a plurality of beacons deployed within the indoor environment, where the measurements are performed by the mobile device. The system also includes determine obtain translated coordinates for at least one beacon in the plurality of beacons deployed in the indoor environment, where the translated coordinates of the at least one beacon are different from physical coordinates associated with the at least one beacon. The system also includes determine an estimated position of the mobile device based at least in part on the translated coordinates of the at least one beacon. Other embodiments of this aspect include corresponding computer systems, apparatus, and computer programs recorded on one or more computer storage devices, each configured to perform the actions of the methods.

Implementations may include one or more of the following features. The computer system where the at least one processor is configured to provide the estimated position of the mobile device to be displayed on a map of the retail store provided by a software application running on the mobile device. The at least one processor is configured to determine the translated coordinates for the at least one beacon based on an offset from the physical coordinates associated with the at least one beacon. The at least one processor is configured to determine the translated coordinates for the at least one beacon based at least in part on a density of beacons in an area of the indoor environment in which the at least one beacon is also located. The at least one processor is configured to determine the translated coordinates for the at least one beacon based on at least an expected interference associated with the at least one beacon, whether the at least one beacon is expected to be active at a given time, a floor plan of the indoor environment, or a combination thereof. Implementations of the described techniques may include hardware, a method or process, or computer software on a computer-accessible medium.

One general aspect includes a non-transitory computer-readable medium having instructions embedded thereon. The non-transitory computer-readable medium also includes obtaining a plurality of measurements of radio frequency (RF) signals transmitted by a plurality of beacons deployed within an indoor environment, where the measurements are performed by a mobile device. The medium also includes determining obtaining translated coordinates for at least one beacon in the plurality of beacons deployed in the indoor environment, where the translated coordinates of the at least one beacon are different from physical coordinates associated with the at least one beacon. The medium also includes determining an estimated position of the mobile device based at least in part on the translated coordinates of the at least one beacon. Other embodiments of this aspect include corresponding computer systems, apparatus, and computer programs recorded on one or more computer storage devices, each configured to perform the actions of the methods.

Implementations may include one or more of the following features. The non-transitory computer-readable medium where the instructions cause the one or more processors to provide the estimated position of the mobile device to be displayed on a map of the retail store provided by a software application running on the mobile device. The instructions cause the one or more processors to determine the translated coordinates for the at least one beacon based on an offset from the physical coordinates associated with the at least one beacon. The instructions cause the one or more processors to determine the translated coordinates for the at least one beacon based at least in part on a density of beacons in an area of the indoor environment in which the at least one beacon is also located. The instructions cause the one or more processors to determine the translated coordinates for the at least one beacon based on at least an expected interference associated with the at least one beacon, whether the at least one beacon is expected to be active at a given time, a floor plan of the indoor environment, or a combination thereof. Implementations of the described techniques may include hardware, a method or process, or computer software on a computer-accessible medium.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is an illustration of an example store aisle, according to an embodiment.

FIG. 2 is a floor plan diagram of an example retail environment in which a positioning system is deployed.

FIG. 3 is an example flow diagram of a method of estimating an indoor position of a mobile device based on translated beacon coordinates, according to an embodiment.

FIG. 4 is a floor plan diagram of the example retail environment showing translated beacon coordinates, according to an embodiment.

FIG. 5 is an illustration of an example Voronoi diagram, according to an embodiment.

FIG. 6 is a flow diagram of a method of determining a position based on translated beacon coordinates, according to an embodiment.

FIG. 7 is a block diagram of an embodiment of a mobile device.

FIG. 8 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, as used herein, the term “beacon” refers to an electronic device or component capable of transmitting and/or receiving RF signals. It can be noted, however, that the functions of receiving and transmitting may be performed using separate components or even separate co-located devices. Some of the functionality described herein may be performed by beacons (or beaconing devices) that may or may not be capable of receiving RF signals.

Further, unless otherwise specified, the term “positioning” as used herein may include absolute location determination, relative location determination, ranging, or a combination thereof. Such positioning may include and/or be based on timing, angular, phase, or power measurements, or a combination thereof (which may include RF sensing measurements) for the purpose of location or sensing services.

It can be noted that, although example embodiments described herein are often in reference to a “retail environment” or “retail venue,” embodiments are not so limited. Moreover, the terms “environment” and “venue,” as used herein, may broadly refer to a physical location or space designed or adapted to accommodate or facilitate a particular activity, event, or function, which may be permanent (e.g., a retail store) or temporary (e.g., a concert event), and may encompass indoor and/or outdoor settings. Example venues include buildings, structures, grounds, parks, fields, arenas, stadiums, theaters, auditoriums, convention centers, exhibition halls, gardens, plazas, courtyards, or any other designated areas that serve as a host or setting for a particular purpose, or any combination thereof.

In general, positioning systems in a retail environment can provide useful information to employees and customers alike regarding their location and the location of store items. For example, positioning systems may utilize strategically placed beacons within an indoor environment with known physical coordinates to determine mobile device locations within the indoor environment using signal strength analysis. In this example, each beacon may continuously broadcast a unique identifier and RF signal. A mobile device, such as user equipment (or UE), may receive such signals and determine corresponding received signal strength measurements (e.g., Received Signal Strength Indicator (RSSI) values). A positioning algorithm may calculate the probable location of the mobile device based on the known physical coordinates of beacons and associated received signal strength measurements, for example, based on a weighted average or centroid-based positioning method.

However, such positioning systems may face significant challenges in providing reliable and stable position estimates, particularly in indoor environments. For instance, such positioning systems may often produce erratic and jumpy position estimates, leading to poor perceived accuracy even when absolute errors are within acceptable ranges. In retail settings, the instability of these positioning systems is especially pronounced. Position estimates can rapidly fluctuate between opposite sides of an aisle due to high received signal strength values. This erratic behavior can disorient users and diminish the positioning system's practical utility. In some instances, position estimates may place a mobile device in an entirely wrong aisle, presenting perceptual and functional issues. Attempts to mitigate these problems through filtering consecutive position estimates to smooth user trajectories have shown limited success. While filtering can slightly improve stability, it may introduce lag and not fully address the underlying issues of signal variability and environmental interference.

Embodiments disclosed herein address these and other issues by improving mobile device position estimation. As discussed herein, aspects may include a positioning system that calculates a location of a mobile device within an indoor environment based on translated beacon coordinates rather than known (or physical) beacon coordinates. The physical beacon coordinates may be translated using various techniques described herein. For example, electronic shelf labels (ESLs) placed in a retail environment may include respective beacons (or transmitters). According to some aspects, physical coordinates for some or all of the ESLs may be translated for purposes of calculating mobile device position. In some aspects, the translation may involve offsetting physical coordinates associated with an ESL attached to a shelf front by some amount into the center of the aisle that the ESL is facing. In such aspects, such translation has the effect of biasing position estimates towards the center of the aisle, and towards areas with higher beacon density. According to some aspects, the translation may involve dynamically calculating translated positions of the beacons using a Voronoi diagram that partitions the indoor environment into regions, with each region being associated with a single beacon (or vertex). In such aspects, the translation from physical coordinates to translated coordinates for positioning purposes may be achieved by using each region's centroid (or center of mass) as a translated position of the associated beacon. As discussed herein, other translation approaches are contemplated, including translating beacon coordinates based on beacon density, floor plan, expected interference, or which beacons are expected to be active at a given time. Embodiments may be used in other environments and applications in which mobile device location and proximity detection to beacons placed throughout an environment may be desirable, such as a warehouse, factory floor, or other commercial or industrial environments.

Particular aspects of the subject matter described in this disclosure can be implemented to realize one or more of the following potential advantages. In some examples, by converting physical beacon coordinates to translated beacon coordinates, positioning systems that calculate mobile device position based on weighted average or centroid-based positioning may provide improved position accuracy, especially in indoor environments. Position estimates based on such translated beacon coordinates may also provide more accurate and smoother mobile device trajectories. These and other advantages will be apparent to a person of ordinary skill in the art in view of the description of the various embodiments provided in this disclosure. Embodiments are provided after a brief description of relevant background information.

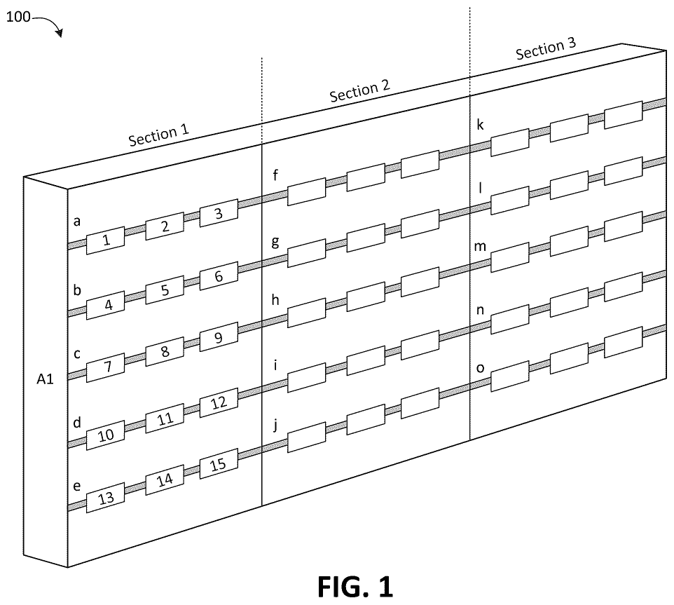

FIG. 1 is an illustration of an example store aisle 100, according to an embodiment, provided here to establish basic terminology used throughout this disclosure. In this example, aisle “A1” includes three sections (which also may be referred to as “units”), where each section is divided into different shelves, each having a respective “rail” affixed or coupled thereto (e.g., fastened to the front of the shelf). In FIG. 1, rails are labeled alphabetically: section 1 has rails a-e, section 2 has rails f-j, and section 3 has rails k-o. Further, a set of electronic shelf labels (ESLs), also known as “digital store labels” (DSLs)) are clipped into place or otherwise coupled to each rail. Each ESL includes a display, which is typically a low-power display, such as an electronic paper or electronic ink (e-ink) display. ESL can display information regarding items on the shelves to which the ESL is coupled, including name, price, description, stock keeping unit (SKU), and/or the like. In FIG. 1, ESLs in section 1 are labeled 1-15. To avoid clutter, ESLs are not labeled in sections 2 or 3.

The usage of beacons in an aisle such as aisle 100 may vary, depending on desired functionality. According to some embodiments, each rail may have a beacon capable of transmitting and receiving information (e.g., via BLUETOOTH or BLUETOOTH LOW ENERGY (BLE)). In such embodiments, these rail beacons may receive updated item information (e.g., from a store computer) for one or more ESLs located on the rail and configure the one or more ESLs (e.g., using over-the-air (OTA) updates) to indicate the updated information. Additionally, or alternatively, each ESL may have its own beacon capable of transmitting and receiving RF signals with a corresponding rail beacon and/or another wireless transceiver. Some embodiments may not use rail beacons, or may not use rails at all, in which case ESLs may have beacons that perform the functionality described in the embodiments herein. Regardless of how beacons are set up (e.g., one beacon per rail or one beacon per ESL), embodiments may translate physical beacon coordinates for some or all of the beacons within an indoor setting to corresponding translated beacon coordinates in a manner that improves indoor positioning estimation.

It can be noted that the size, shape, and quantity of the various components illustrated in FIG. 1 can vary. An aisle may have a different number of sections than illustrated, sections may have a different number of shelves/rails, and/or rails may have different numbers of ESLs. Further, shelves/rails and/or ESLs may be movable to accommodate items of different sizes. Aisles with large items may have relatively few rails and/or ESLs (and, therefore, relatively few beacons), whereas aisles with small items may have relatively many rails and/or ESLs (and, therefore, relatively many beacons).

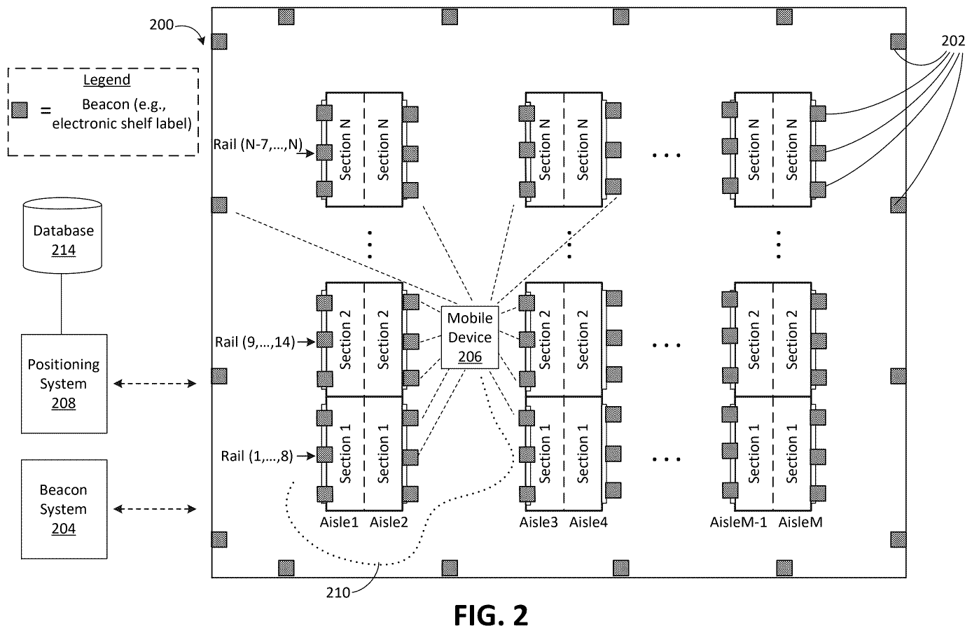

FIG. 2 is a floor plan diagram of an example retail environment in which a positioning system is deployed. As with other figures provided herein, FIG. 2 is provided as a nonlimiting example. Other floor plans may have other features. For example, some floor plans may have aisles that are not back-to-back with other aisles (e.g., aisles against a wall of the retail venue), aisles that shared walkways with more than one aisle (e.g., one long aisle that shares a walkway with two or more shorter aisles), or the like. Further, floor plans may have aisles that extend in different directions (e.g., not parallel), aisles that are not straight, and/or have other features that are not illustrated in FIG. 2. Embodiments described herein may apply to a wide variety of floor plans that may include features not illustrated in FIG. 2.

In FIG. 2, aisles 1-M are illustrated, where each aisle has N sections, and each section has rails. The number of rails, aisles, and sections may vary, depending on the desired floor plan. As illustrated, aisles may be “back-to-back” with other aisles: aisles 1 and 2 are back-to-back, and so are aisles 3 and 4. Aisles 2 and 3, however, share a walkway. Further, although not illustrated in FIG. 2, aisles may be located in different “zones” of a retail venue. In this example, a set of beacons 202 corresponding to electronic shelf labels (ESLs) may be deployed throughout the retail environment 200. For example, the ESLs may be clipped into place or otherwise coupled to rails. The placement of an ESL may depend on a location of a product to which the ESL corresponds.

The beacons 202 may be in communication with one or more computer systems, such as a beacon system 204, for example, over networking infrastructure, to enable functionality, such as positioning the mobile device 206 within the retail environment 200. For example, the networking infrastructure may include wireless access points, such as Wi-Fi or BLUETOOTH LOW ENERGY (BLE) access points deployed throughout the store that establish communication links between the beacon system 204 and the beacons 202. In this example, a beacon 202 may be associated with a transceiver configured to transmit and receive information (e.g., BLE messages). For example, each of the beacons 202 may broadcast signals, which may be received by the mobile device 206 and used to measure received signal strength (e.g., Received Signal Strength Indicator (RSSI) values). Based on the received signal strength measurements, a positioning system 208 and/or the mobile device 206 may estimate a position of the mobile device 206, such as a weighted centroid position. The mobile device 206 may report the received signal strength measurements to the positioning system 208.

The positioning system 208 and/or the mobile device 206 may interact with a database 214. The database 214 may store detailed information about each beacon 202 deployed in the retail environment 200, including a unique identifier and physical coordinates (e.g., global WGS84 coordinates, local coordinates within the retail environment 200, etc.). In some instances, the beacons 202 themselves may provide, or periodically broadcast, their unique identifiers and physical coordinates, among other information.

For example, the mobile device 206 may be held or otherwise associated with a person, such as a customer. The mobile device 206 may be configured to evaluate RF signals received from some or all of the beacons 202 to estimate a position of the mobile device 206. A software application running on the mobile device 206 may provide a graphical user interface that displays a map of the retail environment 200 along with an indicator corresponding to the estimated position of the mobile device 206. In this example, the mobile device 206 may process the RF signals received from nearby beacons 202 to determine (or estimate) the position of the mobile device 206. For example, the position of the mobile device 206 may be determined as a weighted average calculation or a weighted centroid localization calculation using the known physical coordinates of the beacons 202 and corresponding received signal strength measurements.

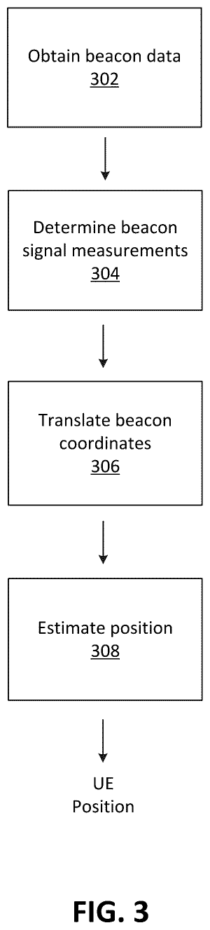

However, as discussed earlier, positioning systems that rely on physical coordinates of the beacons 202 and received signal strength (RSSI) measurements may provide unreliable and unstable position estimates. According to embodiments described herein, the reliability and stability of position estimates may be improved by translating the physical coordinates of the beacons 202 to translated coordinates. In such embodiments, mobile device position estimates may be calculated using the translated coordinates for beacons 202 from which received signal strength measurements were determined. For example, FIG. 3 shows an example approach for translating physical beacon coordinates to translated beacon coordinates, and using the translated beacon coordinates to calculate mobile device position.

FIG. 3 is an example flow diagram of a method of estimating an indoor position of a mobile device based on translated beacon coordinates, according to an embodiment. Means and/or structure for performing the functionality illustrated in one or more of the blocks shown in FIG. 3 may be performed by hardware and/or software components of one or more computer systems (e.g., store computer and/or server, such as the positioning system 208). Some embodiments may perform one or more of the operations illustrated in FIG. 3 using a mobile device (which may be viewed as a mobile computer system, such as the mobile device 206).

At block 302, the functionality comprises obtaining beacon data corresponding to beacons deployed in an indoor environment. For example, the beacon data may be obtained from a database managed by a server of a positioning system for the indoor environment. The server may maintain the database, which may store associations between beacon identifiers (e.g., MAC addresses, UUIDs, etc.) and their corresponding physical coordinates (e.g., global WGS84 coordinates, local coordinates within the indoor environment, etc.) within the indoor environment. In other examples, the database may also store associations between beacon identifiers and transmission power information, associations between beacon identifiers and product information, and other metadata helpful for positioning. In some embodiments, the database may store information describing a floor plan of the indoor environment. In such embodiments, the floor plan may be used to determine respective aisles adjacent to beacons deployed in the indoor environment. In some embodiments, the database may store orientation information (e.g., directional vectors) for beacons in the indoor environment. Depending on the implementation, the orientation information may indicate a direction pointing to the center of an aisle along which a beacon is placed or which direction a given beacon is facing within the indoor environment.

At block 304, the functionality comprises determining received signal strength measurements based on RF signals broadcasted by some or all of the beacons deployed in the indoor environment. For example, a mobile device, such as a smartphone, may receive signals broadcasted by the beacons. The beacons may broadcast beacon data containing their unique identifiers and other metadata. When the mobile device comes within range of these beacons, the mobile device may detect these signals. For each detected beacon, the mobile device may calculate a received signal strength measurement, such as a Received Signal Strength Indicator (RSSI) value.

At block 306, the functionality comprises translating physical coordinates for some or all of the beacons from which broadcasts were received to translated coordinates.

Depending on the implementation, the translation may be performed by the server of the positioning system or a mobile device within the indoor environment. For example, in some embodiments, the server may translate physical coordinates to translated coordinates, and may store the translated coordinates in association with their corresponding beacon identifiers in the database. In some embodiments, after translating, the server may provide the translated coordinates, among other beacon data, in messages (e.g., assistance data messages) to mobile devices. In other embodiments, a mobile device may translate physical beacon coordinates to translated beacon coordinates as a one-off operation. For example, the mobile device may obtain beacon data from the database managed by the server, which may provide beacon identifiers, corresponding physical coordinates to be used for the translation, and respective orientation information.

According to various embodiments, physical coordinates may not be translated for all beacons in an indoor environment. In such embodiments, determinations may be made whether the physical coordinates of a given beacon are translated to translated coordinates based on various considerations.

In some embodiments, the determination to translate the physical coordinates of a beacon to translated coordinates may be based on beacon density. For example, a spatial bias may occur due to uneven beacon distribution throughout a retail store. For example, beacons may be positioned with lower density along store perimeters (e.g., walls 404) and with greater density along central aisles. In such embodiments, a determination may be made to translate the physical coordinates of beacons in locations with higher beacon density (e.g., aisles) and to not translate the physical coordinates of beacons in locations with lower beacon density (e.g., along store perimeter). Such translation may create an artificial gravitational effect that pulls position estimates toward the edges of the retail space, thereby countering any bias of positioning algorithms to skew position estimates toward areas of higher beacon density. Such bias may occur due to the nature of weighted average calculations, which give disproportionate influence to areas where signal sources are clustered more densely. By not translating beacons in areas with lower beacon density, such as those along a store periphery, this technique may help balance such bias. In general, beacon density may be measured using various approaches, such as beacons per unit area, which may measure the number of beacons deployed per square meter (or square foot). According to some embodiments, beacon density thresholds may be applied to determine whether to translate the physical coordinates of a given beacon. For example, physical coordinates for beacons in areas with a beacon density greater than a threshold number of beacons per unit square may be translated while beacons in less dense areas are not translated. In other instances, physical coordinates for beacons in areas with a beacon density less than a threshold number of beacons per unit square may be translated while beacons in more dense areas are not translated. Many variations are possible. In some embodiments, a beacon that is sufficiently isolated from other beacons based on their physical coordinates may be configured to transmit signals at a higher power or higher rate to increase its likelihood of detection, which may improve position estimates.

In some embodiments, the determination to translate the physical coordinates of a beacon to translated coordinates may be based on which beacons are expected to be broadcasting at a given time. For example, expected beacon broadcasting may be determined based on various techniques, such as scheduled broadcasting schedules (or patterns). As an example, a broadcasting schedule may be determined based on time-division multiplexing, which allows beacons to broadcast at predetermined time slots within a cycling schedule. This approach may require synchronization across the beacons and may be managed by the server of the positioning system, which maintains a master clock. The server may store and distribute broadcasting schedules, assigning specific time slots to each beacon based on its unique identifier. When a mobile device queries the system about which beacons should be active, the server can reference the current time against these schedules to determine the expected active broadcasting set of beacons. In such embodiments, the physical coordinates of beacons that are expected to be broadcasting at a given time may be translated while physical coordinates of the remaining, unactive, beacons remain untranslated.

In some embodiments, the determination to translate the physical coordinates of a beacon may be based on expected beacon interference. For example, expected beacon interference may be determined based on methods, such as signal-to-noise ratio analysis, received signal strength indicator (RSSI) variance monitoring, or loss rate calculation. In some embodiments, the physical coordinates of beacons for which interference is expected at a given time may not be translated to translated coordinates while physical coordinates of beacons for which interference is not expected may be translated to translated coordinates.

In some embodiments, the determination to translate the physical coordinates of a beacon to translated coordinates may be based on signal attenuation that results from a context associated with a mobile device. In various embodiments, the mobile device context may be determined based on body shadowing, mobile device type (e.g., smartphone, smartwatch, smart glasses, etc.), co-location of mobile devices (e.g., a smartphone and smartwatch), or a combination thereof.

For instance, when a mobile device is used for indoor positioning, signal attenuation (or blocking) resulting from body shadowing may affect the accuracy of the mobile device's estimated position due to the presence of the human body between a transmitting device (e.g., a beacon) and a receiving device (e.g., the mobile device). For example, such attenuation may be caused by the mobile device being in a user's pocket or otherwise blocked by the user's body. In various embodiments, body shadowing may be detected based on inertial measurement units (IMUs) or other sensors in a mobile device that are employed to detect user orientation and infer when the user's body is likely blocking signals from certain beacons. For example, if a user is facing away from a beacon and the mobile device is in a back pocket, the system can flag the signal as potentially shadowed. In such embodiments, physical coordinates of beacons affected (e.g., blocked, or otherwise experiencing signal degradation) by body shadowing may be converted to translated coordinates to compensate for the attenuation and improve positioning of the mobile device, as described herein.

In another example, in some cases, mobile device type may affect signal attenuation and, as a result, the positioning of a mobile device. For example, smart glasses may present signal attenuation challenges due to their form factor and proximity to the human head. In general, smart glasses may implement antennas positioned within the glass arms, which may experience attenuation patterns related to their separation and orientation relative to the head. Further, the separated nature of these antennas, which are typically positioned on opposite sides of the head, may create special challenges. For instance, smart glasses may experience RF losses due to their proximity to the human head, which may absorb RF signals. In various embodiments, mobile device type may be determined and used to identify beacons that may be blocked or otherwise attenuated due to mobile device type. In such embodiments, physical coordinates of the identified beacons may be converted to translated coordinates to compensate for the attenuation and improve positioning of the mobile device, as described herein.

In yet another example, in some cases, co-location of mobile devices may also introduce attenuation and, as a result, degrade mobile device positioning. For example, when multiple mobile devices are co-located on or near a user's body, such as a smartphone and smartwatch, the mobile devices may experience mutual interference and complex attenuation patterns. The interference between these mobile devices may vary based on their relative positions and the body parts between them. In various embodiments, the presence of co-located mobile devices may be determined and used to identify beacons that may be blocked or otherwise attenuated due to the co-located mobile devices. In such embodiments, physical coordinates of the identified beacons may be converted to translated coordinates to compensate for the attenuation and improve positioning of the mobile device, as described herein.

The physical coordinates of beacons may be converted to translated coordinates using various approaches. In some embodiments, translated coordinates represent a theoretical (or phantom) position of a beacon, and, depending on the implementation, the translated coordinates may be represented as a set of position coordinates for the beacon or as an offset from the physical coordinates of the beacon.

In some embodiments, translated coordinates for a beacon in a retail environment may be determined by projecting the physical coordinates of the beacon towards the center of an aisle along which the beacon is placed. The direction of the aisle may be determined based on orientation information associated with the beacon. In various embodiments, the amount of offset between the physical coordinates and the translated coordinates may be based on aisle width, such that the translated coordinates correspond to a location at or near the center of the aisle. In some embodiments, store information, such as aisle configuration and width, may be provided by a floor plan of the retail environment.

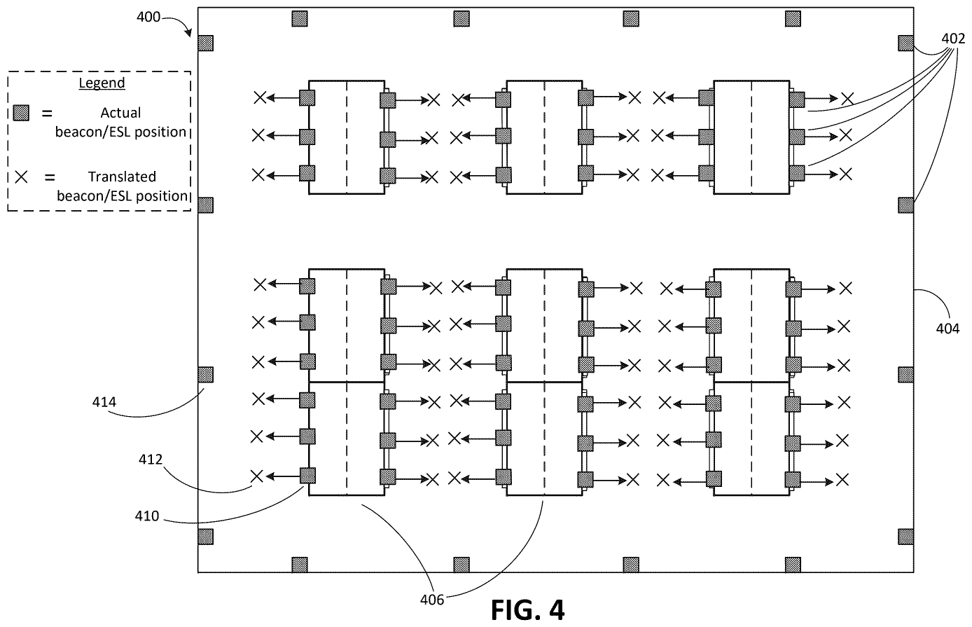

For example, FIG. 4 is a floor plan diagram of an example retail environment showing translated beacon coordinates, according to an embodiment. In this example, the diagram 400 shows a floor plan view of a retail store. The diagram 400 shows a number of beacons 402 deployed throughout the retail store. For example, the beacons 402 may be included in electronic shelf labels (ESLs) placed throughout the retail store. In this example, some beacons 402 are deployed along walls 404 of the retail store while others are deployed along aisles 406. In FIG. 4, physical coordinates for some of the beacons 402 are translated to translated coordinates for purposes of position estimation while others remain untranslated. In the diagram 400, the physical coordinates of the beacons 402 are represented using boxes. In contrast, translated coordinates of the beacons 402, if translated, are identified by the letter “X”. For example, the physical coordinates corresponding to a beacon 410 placed along an aisle are translated to translated coordinates 412. In the example of FIG. 4, the physical coordinates of a beacon 414 placed along a perimeter wall of the retail environment are not translated, for example, due to a lack of beacon density.

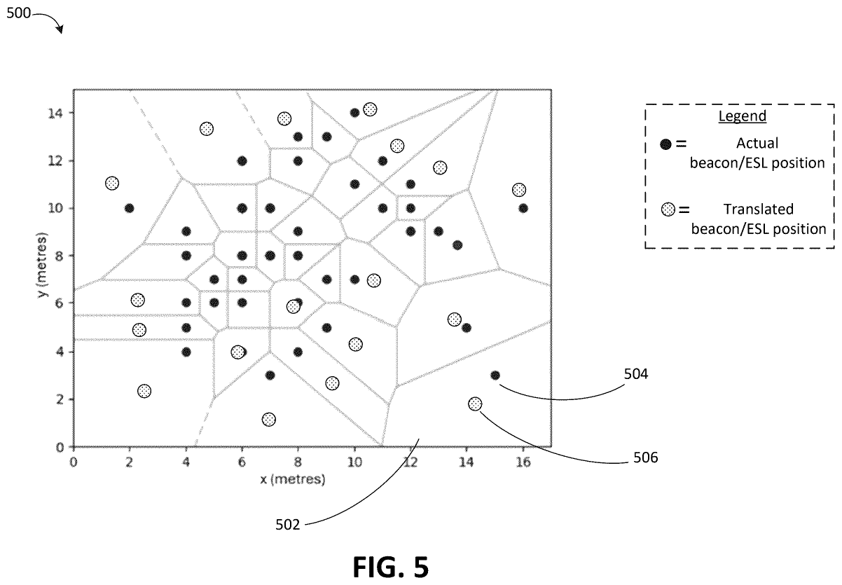

In some embodiments, translated coordinates for a beacon in an indoor environment may be determined dynamically. For example, in some embodiments, a Voronoi diagram may be used to partition the indoor environment into regions. Each region may be associated with exactly one vertex which corresponds to a beacon deployed in the indoor environment. In such embodiments, the physical coordinates of a beacon associated with a Voronoi region may be translated for positioning purposes using the centroid (or center of mass) of the Voronoi region as translated coordinates for the beacon. The centroid of the Voronoi region may be determined using existing methods for calculating the center of mass of a polygon. For example, FIG. 5 shows an illustration of an example Voronoi diagram 500, according to an embodiment. In this example, the Voronoi diagram 500 partitions an indoor environment into regions. Each region may be associated with exactly one vertex which corresponds to a beacon deployed in the indoor environment. For example, a region 502 is associated with a vertex, which corresponds to the physical coordinates 504 associated with a beacon. In various embodiments, the translated coordinates for the physical coordinates 504 of the beacon may correspond to a centroid 506 of the region 502.

According to some embodiments, in environments where beacons are deployed non-uniformly, such translation may be restricted to beacons in low density areas, such as areas where the beacon density is below a density threshold. In FIG. 5, only the transmitter positions in low density areas have been translated. In some embodiments, beacons located along a perimeter of the indoor environment are not translated in order to maximize the convex hull for position estimation. In some instances, an indoor environment may include obstacles that limit beacon placement, which may result in areas with lower beacon density. In such instances, a Voronoi diagram of the indoor environment may need to account for such obstacles; otherwise, translated coordinates determined for beacons in such areas may be inside such obstacles.

At block 308, the functionality may comprise estimating a position of a mobile device in the indoor environment. The position estimate of the mobile device may be calculated using beacon coordinates and received signal strength (RSSI) measurements, for example, a weighted centroid calculation. In this approach, the coordinates of each detected (or broadcasting) beacon are combined into a single estimated position, with each beacon's contribution weighted according to its measured RSSI value. Since RSSI generally decreases with increasing distance, stronger signals may indicate closer proximity; thus, beacons with higher RSSI values may be assigned greater weights in the calculation. In various embodiments, when estimating the position of the mobile device, translated coordinates determined for the beacons, if any, are used to calculate mobile device position as opposed to the actual physical coordinates associated with those beacons. In such embodiments, physical coordinates continue of beacons without translated coordinates continue to be used in conjunction with the translated coordinates for purposes of position estimation.

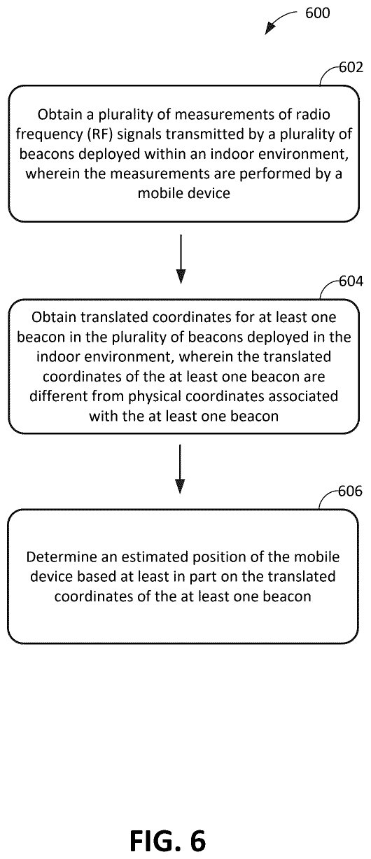

FIG. 6 is a flow diagram of a method of determining a position based on translated beacon coordinates, according to an embodiment. Means and/or structure for performing the functionality illustrated in one or more of the blocks shown in FIG. 6 may be performed by hardware and/or software components of one or more computer systems (e.g., store computer and/or server, such as the positioning system 208). Some embodiments may perform one or more of the operations illustrated in FIG. 6 using a mobile device (which may be viewed as a mobile computer system, such as the mobile device 206).

At block 602, a plurality of measurements of radio frequency (RF) signals transmitted by a plurality of beacons deployed within the indoor environment may be obtained. The measurements may be performed by a mobile device.

At block 604, translated coordinates for at least one beacon in the plurality of beacons deployed in the indoor environment may be obtained. The translated coordinates of the at least one beacon may be different from physical coordinates associated with the at least one beacon.

At block 606, an estimated position of the mobile device may be determined based at least in part on the translated coordinates of the at least one beacon.

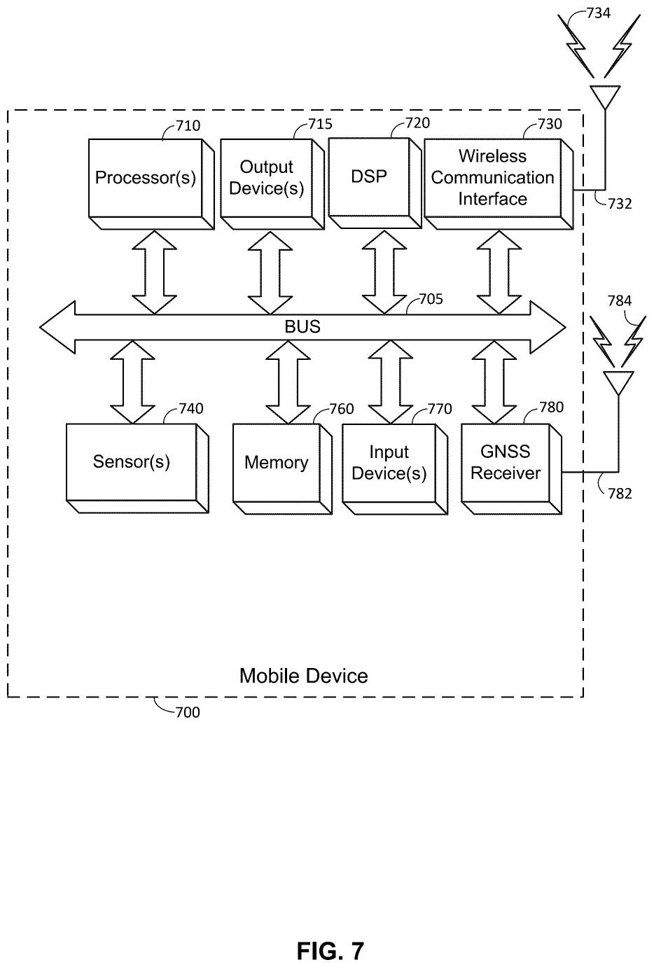

FIG. 7 is a block diagram of an embodiment of a mobile device 700, which can be utilized as described herein (e.g., in association with the previously described figures). The mobile device can be used, for example, to perform measurements of transceivers as described herein for purposes of translating the physical coordinates of beacons in an indoor environment to respective translated coordinates. It should be noted that FIG. 7 is meant only to provide a generalized illustration of various components, any or all of which may be utilized as appropriate. Furthermore, the functionality of the mobile device discussed herein may be executed by one or more of the hardware and/or software components illustrated in FIG. 7.

The mobile device 700 is shown comprising hardware elements that can be electrically coupled via a bus 705 (or may otherwise be in communication, as appropriate). The hardware elements may include a processor(s) 710, which can include without limitation one or more general-purpose processors (e.g., an application processor), one or more special-purpose processors (such as DSP chips, graphics acceleration processors, application-specific integrated circuits (ASICs), and/or the like), and/or other processing structures or means. Processor(s) 710 may comprise one or more processing units, which may be housed in a single integrated circuit (IC) or multiple ICs. As shown in FIG. 7, some embodiments may have a separate DSP 720, depending on the desired functionality. Location determination and/or other determinations based on wireless communication may be provided in the processor(s) 710 and/or wireless communication interface 730 (discussed below). The mobile device 700 also can include one or more input devices 770, which can include without limitation one or more keyboards, touch screens, touch pads, microphones, buttons, dials, switches, and/or the like; and one or more output devices 715, which can include without limitation one or more displays (e.g., touch screens), light emitting diodes (LEDs), speakers, and/or the like.

The mobile device 700 may also include a wireless communication interface 730, which may comprise without limitation a modem, a network card, an infrared communication device, a wireless communication device, and/or a chipset (such as a Bluetooth® device (including BLE), an IEEE 802.11 device, an IEEE 802.15.4 device, a Wi-Fi device, a WiMAX device, a WAN device, and/or various cellular devices, etc.), and/or the like, which may enable the mobile device 700 to communicate with other devices (e.g., a store computer, a cloud service, etc.) and/or perform measurements of transceivers as described in the embodiments above. The wireless communication interface 730 may permit data and signaling to be communicated (e.g., transmitted and received) with communication networks (cellular, Wi-Fi, etc.) via access points, base stations, and/or other access node types, and/or other network components, computer systems, and/or any other electronic devices communicatively coupled with the communication network. The communication can be carried out via one or more wireless communication antenna(s) 732 that send and/or receive wireless signals 734. According to some embodiments, the wireless communication antenna(s) 732 may comprise a plurality of discrete antennas, antenna arrays, or any combination thereof. The antenna(s) 732 may be capable of transmitting and receiving wireless signals using beams (e.g., Tx beams and Rx beams). Beam formation may be performed using digital and/or analog beam formation techniques with respective digital and/or analog circuitry. The wireless communication interface 730 may include such circuitry.

Depending on desired functionality, the wireless communication interface 730 may comprise a separate receiver and transmitter or any combination of transceivers, transmitters, and/or receivers to communicate with base stations and other terrestrial transceivers, such as wireless devices and access points. The mobile device 700 may communicate with different data networks that may comprise various network types. For example, one such network type may comprise a wireless wide area network (WWAN), which may be a code-division multiple access (CDMA) network, a time division multiple access (TDMA) network, a frequency division multiple access (FDMA) network, an orthogonal frequency division multiple access (OFDMA) network, a single-carrier frequency division multiple access (SC-FDMA) network, a WiMAX (IEEE 802.16) network, and so on. A CDMA network may implement one or more radio access technologies (RATs) such as CDMA2000®, wideband code division multiple access (WCDMA), and so on. CDMA2000® includes IS-95, IS-2000 and/or IS-856 standards. A TDMA network may implement global system for mobile communications (GSM), digital advanced mobile phone system (D-AMPS), or some other RAT. An OFDMA network may employ long-term evolution (LTE), LTE Advanced, fifth-generation (5G) new radio (NR), and so on. 5G NR, LTE, LTE Advanced, GSM, and WCDMA are described in documents from 3rd Generation Partnership Project (3GPP). CDMA 2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The mobile device 700 can further include sensor(s) 740. Sensor(s) 740 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the mobile device 700 may also include a Global Navigation Satellite System (GNSS) receiver 780 capable of receiving signals 784 from one or more GNSS satellites using an antenna 782 (which could be the same as antenna 732). Positioning based on GNSS signal measurement can be utilized to complement and/or incorporate the techniques described herein. The GNSS receiver 780 can extract a position of the mobile device 700, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 780 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 780 is illustrated in FIG. 7 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 710, DSP 720, and/or a processor within the wireless communication interface 730 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 710 or DSP 720.

The mobile device 700 may further include and/or be in communication with a memory 760. The memory 760 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 760 of the mobile device 700 also can comprise software elements (not shown in FIG. 7), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 760 that are executable by the mobile device 700 (and/or processor(s) 710 or DSP 720 within mobile device 700). In some embodiments, then, such code and/or instructions can be used to configure and/or adapt a general-purpose computer (or other device) to perform one or more operations in accordance with the described methods.

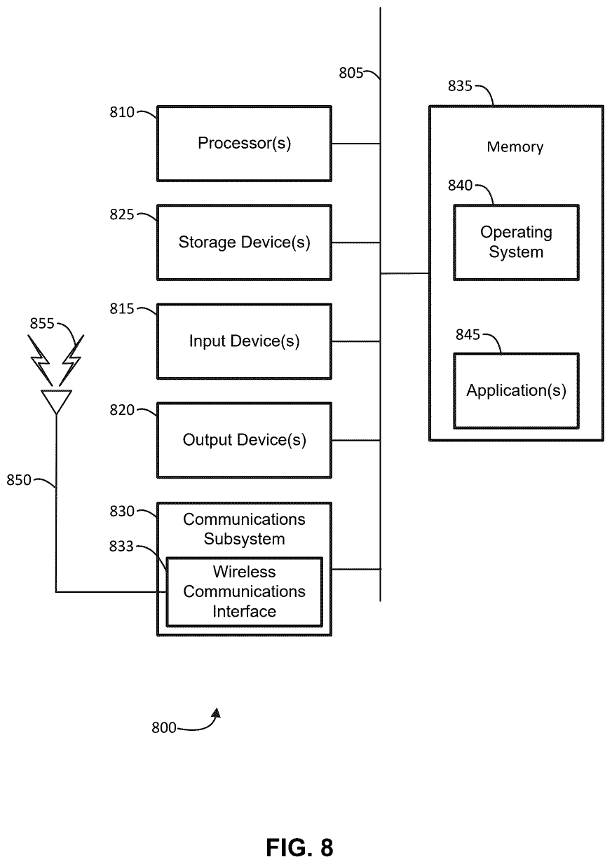

FIG. 8 is a block diagram of an embodiment of a computer system 800, which may be used, in whole or in part, to provide the functions of one or more components, servers, and/or devices as described in the embodiments herein (e.g., a store computer and/or cloud server). This may include, for example, a computer server, personal computer, personal electronic device, or the like. It should be noted that FIG. 8 is meant only to provide a generalized illustration of various components, any or all of which may be utilized as appropriate. FIG. 8, therefore, broadly illustrates how individual system elements may be implemented in a relatively separated or relatively more integrated manner. In addition, it can be noted that components illustrated by FIG. 8 can be localized to a single device and/or distributed among various networked devices, which may be disposed at different geographical locations.

The computer system 800 is shown comprising hardware elements that can be electrically coupled via a bus 805 (or may otherwise be in communication, as appropriate). The hardware elements may include processor(s) 810, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 800 also may comprise one or more input devices 815, which may comprise without limitation a mouse, a keyboard, a camera, a microphone, and/or the like; and one or more output devices 820, which may comprise without limitation a display device, a printer, and/or the like.

The computer system 800 may further include (and/or be in communication with) one or more non-transitory storage devices 825, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 800 may also include a communications subsystem 830, which may comprise wireless communication technologies managed and controlled by a wireless communication interface 833, as well as wired technologies (such as Ethernet, coaxial communications, universal serial bus (USB), and the like). The wireless communication interface 833 may comprise one or more wireless transceivers that may send and receive wireless signals 855 (e.g., signals according to 5G NR or LTE) via wireless antenna(s) 850. Thus the communications subsystem 830 may comprise a modem, a network card (wireless or wired), an infrared communication device, a wireless communication device, and/or a chipset, and/or the like, which may enable the computer system 800 to communicate on any or all of the communication networks described herein to any device on the respective network, including a User Equipment (UE), base stations and/or other transmission reception points (TRPs), and/or any other electronic devices described herein. Hence, the communications subsystem 830 may be used to receive and send data as described in the embodiments herein.

In many embodiments, the computer system 800 will further comprise a working memory 835, which may comprise a RAM or ROM device, as described above. Software elements, shown as being located within the working memory 835, may comprise an operating system 840, device drivers, executable libraries, and/or other code, such as one or more applications 845, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 825 described above. In some cases, the storage medium might be incorporated within a computer system, such as computer system 800. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 800 and/or might take the form of source and/or installable code, which, upon compilation and/or installation on the computer system 800 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

Also, it can be noted that terms such as “N” and “M” are used in the description and in the figures to represent some number (e.g., an integer value). However, the reuse of the term in different contexts does not necessarily mean the value is the same in each of those contexts. That is, the value N may be used in two different contexts (even within the same figure), in which case the value may be different in each context.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1 A method of estimating a position of a mobile device located within an indoor environment, the method comprising: obtaining a plurality of measurements of radio frequency (RF) signals transmitted by a plurality of beacons deployed within the indoor environment, wherein the measurements are performed by the mobile device; obtaining translated coordinates for at least one beacon in the plurality of beacons deployed in the indoor environment, wherein the translated coordinates of the at least one beacon are different from physical coordinates associated with the at least one beacon; and determining an estimated position of the mobile device based at least in part on the translated coordinates of the at least one beacon.
Clause 2 The method of clause 1, wherein the indoor environment is a retail store, and wherein the at least one beacon corresponds to an electronic shelf label (ESL) placed within the retail store.
Clause 3 The method of clause 1 or clause 2, wherein the estimated position of the mobile device is displayed in a map of the retail store provided by a software application running on the mobile device.
Clause 4 The method of clauses 1-3, wherein the translated coordinates for the at least one beacon are offset from the physical coordinates associated with the at least one beacon.
Clause 5 The method of clauses 1-4, wherein the translated coordinates for the at least one beacon are determined based at least in part on a density of beacons in an area of the indoor environment in which the at least one beacon is also located.
Clause 6 The method of clauses 1-4, wherein the translated coordinates for the at least one beacon are determined based on at least an expected interference associated with the at least one beacon, whether the at least one beacon is expected to be active at a given time, a floor plan of the indoor environment, a context associated with the mobile device, or a combination thereof.
Clause 7 The method of clauses 1-4, wherein the at least one beacon corresponds to an electronic shelf label (ESL) placed along an aisle within the indoor environment, and wherein the translated coordinates for the at least one beacon are determined based on a projection of the physical coordinates of the at least one beacon towards a center of the aisle.
Clause 8 The method of clauses 1-7, wherein the translated coordinates for the at least one beacon are provided in an assistance data message by a server of a positioning system.
Clause 9 The method of clauses 1-7, wherein the translated coordinates for the at least one beacon are determined based at least in part on information included in an assistance message provided by a server of a positioning system, wherein the assistance data message provides at least orientation information associated with the at least one beacon.
Clause 10 The method of clauses 1-6, clause 8, or clause 9, wherein the translated coordinates for the at least one beacon are determined based at least in part on a Voronoi diagram that partitions the indoor environment into a plurality of regions that each correspond to a beacon in the plurality of beacons, and wherein the translated coordinates correspond to a centroid of a region corresponding to the at least one beacon.
Clause 11 A computer system for estimating a position of a mobile device located within an indoor environment, the computer system comprising: at least one communication interface; at least one memory; and at least one processor communicatively coupled with the at least one communication interface and at least one memory, the at least one processor configured to: obtain a plurality of measurements of radio frequency (RF) signals transmitted by a plurality of beacons deployed within the indoor environment, wherein the measurements are performed by the mobile device; obtain translated coordinates for at least one beacon in the plurality of beacons deployed in the indoor environment, wherein the translated coordinates of the at least one beacon are different from physical coordinates associated with the at least one beacon; and determine an estimated position of the mobile device based at least in part on the translated coordinates of the at least one beacon.
Clause 12 The computer system of clause 11, wherein the at least one processor is configured to provide the estimated position of the mobile device to be displayed on a map of the retail store provided by a software application running on the mobile device.
Clause 13 The computer system of clause 11 or clause 12, wherein the at least one processor is configured to determine the translated coordinates for the at least one beacon based on an offset from the physical coordinates associated with the at least one beacon.
Clause 14 The computer system of clauses 11-13, wherein the at least one processor is configured to determine the translated coordinates for the at least one beacon based at least in part on a density of beacons in an area of the indoor environment in which the at least one beacon is also located.
Clause 15 The computer system of clauses 11-14, wherein the at least one processor is configured to determine the translated coordinates for the at least one beacon based on at least an expected interference associated with the at least one beacon, whether the at least one beacon is expected to be active at a given time, a floor plan of the indoor environment, or a combination thereof.
Clause 16 A non-transitory computer-readable medium having instructions embedded thereon, which, when executed by one or more processors, cause the one or more processors to perform functions comprising: obtaining a plurality of measurements of radio frequency (RF) signals transmitted by a plurality of beacons deployed within an indoor environment, wherein the measurements are performed by a mobile device; obtaining translated coordinates for at least one beacon in the plurality of beacons deployed in the indoor environment, wherein the translated coordinates of the at least one beacon are different from physical coordinates associated with the at least one beacon; and determining an estimated position of the mobile device based at least in part on the translated coordinates of the at least one beacon.
Clause 17 The non-transitory computer-readable medium of clause 16, wherein the instructions cause the one or more processors to provide the estimated position of the mobile device to be displayed on a map of the retail store provided by a software application running on the mobile device.
Clause 18 The non-transitory computer-readable medium of clause 16 or clause 17, wherein the instructions cause the one or more processors to determine the translated coordinates for the at least one beacon based on an offset from the physical coordinates associated with the at least one beacon.
Clause 19 The non-transitory computer-readable medium of clauses 16-18, wherein the instructions cause the one or more processors to determine the translated coordinates for the at least one beacon based at least in part on a density of beacons in an area of the indoor environment in which the at least one beacon is also located.
Clause 20 The non-transitory computer-readable medium of clauses 16-19, wherein the instructions cause the one or more processors to determine the translated coordinates for the at least one beacon based on at least an expected interference associated with the at least one beacon, whether the at least one beacon is expected to be active at a given time, a floor plan of the indoor environment, or a combination thereof.

What is claimed is:

1. A method of estimating a position of a mobile device located within an indoor environment, the method comprising:
obtaining a plurality of measurements of radio frequency (RF) signals transmitted by a plurality of beacons deployed within the indoor environment, wherein the measurements are performed by the mobile device;
obtaining translated coordinates for at least one beacon in the plurality of beacons deployed in the indoor environment, wherein the translated coordinates of the at least one beacon are different from physical coordinates associated with the at least one beacon; and
determining an estimated position of the mobile device based at least in part on the translated coordinates of the at least one beacon.

2. The method of claim 1, wherein the indoor environment is a retail store, and wherein the at least one beacon corresponds to an electronic shelf label (ESL) placed within the retail store.

3. The method of claim 1, wherein the estimated position of the mobile device is displayed in a map of the retail store provided by a software application running on the mobile device.

4. The method of claim 1, wherein the translated coordinates for the at least one beacon are offset from the physical coordinates associated with the at least one beacon.

5. The method of claim 1, wherein the translated coordinates for the at least one beacon are determined based at least in part on a density of beacons in an area of the indoor environment in which the at least one beacon is also located.

6. The method of claim 1, wherein the translated coordinates for the at least one beacon are determined based on at least an expected interference associated with the at least one beacon, whether the at least one beacon is expected to be active at a given time, a floor plan of the indoor environment, a context associated with the mobile device, or a combination thereof.

7. The method of claim 1, wherein the at least one beacon corresponds to an electronic shelf label (ESL) placed along an aisle within the indoor environment, and wherein the translated coordinates for the at least one beacon are determined based on a projection of the physical coordinates of the at least one beacon towards a center of the aisle.

8. The method of claim 1, wherein the translated coordinates for the at least one beacon are provided in an assistance data message by a server of a positioning system.

9. The method of claim 1, wherein the translated coordinates for the at least one beacon are determined based at least in part on information included in an assistance message provided by a server of a positioning system, wherein the assistance data message provides at least orientation information associated with the at least one beacon.

10. The method of claim 1, wherein the translated coordinates for the at least one beacon are determined based at least in part on a Voronoi diagram that partitions the indoor environment into a plurality of regions that each correspond to a beacon in the plurality of beacons, and wherein the translated coordinates correspond to a centroid of a region corresponding to the at least one beacon.

11. A computer system for estimating a position of a mobile device located within an indoor environment, the computer system comprising:
at least one communication interface;
at least one memory; and
at least one processor communicatively coupled with the at least one communication interface and at least one memory, the at least one processor configured to:
obtain a plurality of measurements of radio frequency (RF) signals transmitted by a plurality of beacons deployed within the indoor environment, wherein the measurements are performed by the mobile device;
obtain translated coordinates for at least one beacon in the plurality of beacons deployed in the indoor environment, wherein the translated coordinates of the at least one beacon are different from physical coordinates associated with the at least one beacon; and
determine an estimated position of the mobile device based at least in part on the translated coordinates of the at least one beacon.

12. The computer system of claim 11, wherein the at least one processor is configured to provide the estimated position of the mobile device to be displayed on a map of the retail store provided by a software application running on the mobile device.

13. The computer system of claim 11, wherein the at least one processor is configured to determine the translated coordinates for the at least one beacon based on an offset from the physical coordinates associated with the at least one beacon.

14. The computer system of claim 11, wherein the at least one processor is configured to determine the translated coordinates for the at least one beacon based at least in part on a density of beacons in an area of the indoor environment in which the at least one beacon is also located.

15. The computer system of claim 11, wherein the at least one processor is configured to determine the translated coordinates for the at least one beacon based on at least an expected interference associated with the at least one beacon, whether the at least one beacon is expected to be active at a given time, a floor plan of the indoor environment, or a combination thereof.

16. A non-transitory computer-readable medium having instructions embedded thereon, which, when executed by one or more processors, cause the one or more processors to perform functions comprising:
obtaining a plurality of measurements of radio frequency (RF) signals transmitted by a plurality of beacons deployed within an indoor environment, wherein the measurements are performed by a mobile device;
obtaining translated coordinates for at least one beacon in the plurality of beacons deployed in the indoor environment, wherein the translated coordinates of the at least one beacon are different from physical coordinates associated with the at least one beacon; and
determining an estimated position of the mobile device based at least in part on the translated coordinates of the at least one beacon.

17. The non-transitory computer-readable medium of claim 16, wherein the instructions cause the one or more processors to provide the estimated position of the mobile device to be displayed on a map of the retail store provided by a software application running on the mobile device.

18. The non-transitory computer-readable medium of claim 16, wherein the instructions cause the one or more processors to determine the translated coordinates for the at least one beacon based on an offset from the physical coordinates associated with the at least one beacon.

19. The non-transitory computer-readable medium of claim 16, wherein the instructions cause the one or more processors to determine the translated coordinates for the at least one beacon based at least in part on a density of beacons in an area of the indoor environment in which the at least one beacon is also located.

20. The non-transitory computer-readable medium of claim 16, wherein the instructions cause the one or more processors to determine the translated coordinates for the at least one beacon based on at least an expected interference associated with the at least one beacon, whether the at least one beacon is expected to be active at a given time, a floor plan of the indoor environment, or a combination thereof.
